(19) United States
(12) Patent Application Publication
(10) Pub. No.: US 2017/0002137 A1
(43) Pub. Date: Jan. 5, 2017

(54) Liquid Crystalline Polymer for Use in Melt-Extuded Articles

(71) Applicant: Ticona LLC, Florence, KY (US)

(72) Inventor: Kamlesh P. Nair, Florence, KY (US)

(21) Appl. No.: 15/193,433

(22) Filed: Jun. 27, 2016

Related U.S. Application Data
(60) Provisional application No. 62/187,920, filed on Jul. 2, 2015.

(51) Int. Cl. C08G 63/672; C08J 5/18

(52) U.S. Cl. CPC C08G 63/672; C08J 5/18; C08J 2367/02

(57) ABSTRACT

A melt-polymerized liquid crystalline polymer is provided that comprises repeating units (1) to (5):

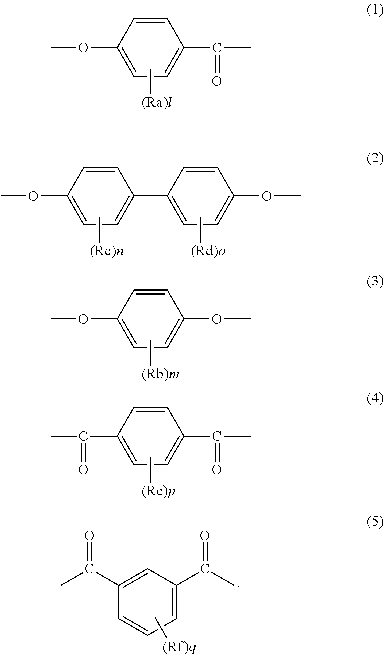

### RELATED APPLICATIONS

The present application claims priority to U.S. Provisional Application Ser. No. 62/187,920, filed on Jul. 2, 2015, which is incorporated herein in its entirety by reference thereto.

### BACKGROUND OF THE INVENTION

Liquid crystalline polymers are wholly aromatic condensation polymers that have relatively rigid and linear polymer chains. Such polymers are generally classified as “thermotropic” to the extent that they can possess a rod-like structure and exhibit a crystalline behavior in the molten state (e.g., thermotropic nematic state). Due to their unique properties, liquid crystalline polymers can perform very well in harsh environments, exhibiting high heat resistance and tolerance, high electrical resistance, and high chemical resistance. Although they have many unique advantages, the polymers have also shown some disadvantages. To form a melt-extruded article from such polymers, for instance, a relatively high melt strength is generally required. Unfortunately, it is often difficult to obtain a liquid crystalline polymer that has the requisite degree of melt strength without sacrificing other important thermal or mechanical properties. As such, a need continues to exist for a liquid crystalline polymer that can be more readily employed in melt-extruded articles.

### SUMMARY OF THE INVENTION

In accordance with one embodiment of the present invention, a melt-polymerized liquid crystalline polymer is disclosed that comprises repeating units (1) to (5):

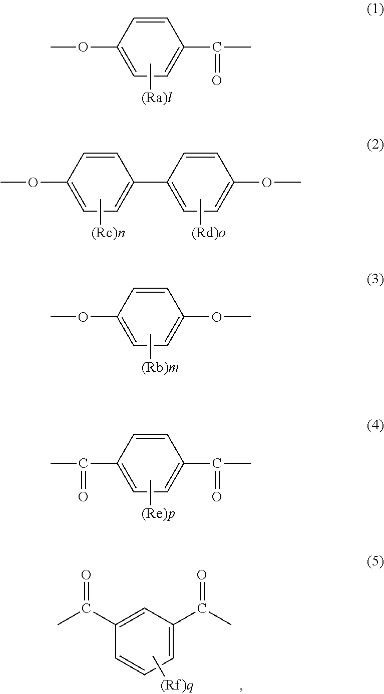

wherein,

Ra, Rb, Rc, Rd, Re and Rf are independently alkenyl, alkyl, alkynyl, aryl, heteroaryl, cycloalkyl, heterocyclyl, halo, or haloalkyl;

l, m, n, o, p and q are independently an integer from 0 to 4;

the repeating units (1) constitute from about 5 mole % to about 45 mole % of the polymer;

the molar ratio of repeating units (2) to the repeating units (3) is from about 0.6 to about 2.5; and

the molar ratio of repeating units (4) to the repeating units (5) is from about 0.7 to about 1.5.

Other features and aspects of the present invention are set forth in greater detail below.

### DETAILED DESCRIPTION

It is to be understood that the terminology used herein is for the purpose of describing particular embodiments only and is not intended to limit the scope of the present invention.

“Alkyl” refers to monovalent saturated aliphatic hydrocarbyl groups having from 1 to 10 carbon atoms and, in some embodiments, from 1 to 6 carbon atoms. “C_{x-y}alkyl” refers to alkyl groups having from x to y carbon atoms. This term includes, by way of example, linear and branched hydrocarbyl groups such as methyl (CH₃), ethyl (CH₃CH₂), n-propyl (CH₃CH₂CH₂), isopropyl ((CH₃)₂CH), n-butyl (CH₃CH₂CH₂CH₂), isobutyl ((CH₃)₂CHCH₂), sec-butyl ((CH₃)(CH₃CH₂)CH), t-butyl ((CH₃)₃C), n-pentyl (CH₃CH₂CH₂CH₂CH₂), and neopentyl ((CH₃)₃CCH₂).

“Alkenyl” refers to a linear or branched hydrocarbyl group having from 2 to 10 carbon atoms and in some embodiments from 2 to 6 carbon atoms or 2 to 4 carbon atoms and having at least 1 site of vinyl unsaturation (>C═C<). For example, (Cₓ-C_{y})alkenyl refers to alkenyl groups having from x to y carbon atoms and is meant to include for example, ethenyl, propenyl, 1,3-butadienyl, and so forth.

“Alkynyl” refers to a linear or branched monovalent hydrocarbon radical containing at least one triple bond. The term “alkynyl” may also include those hydrocarbyl groups having other types of bonds, such as a double bond and a triple bond.

“Aryl” refers to an aromatic group of from 3 to 14 carbon atoms and no ring heteroatoms and having a single ring (e.g., phenyl) or multiple condensed (fused) rings (e.g., naphthyl or anthryl). For multiple ring systems, including fused, bridged, and spiro ring systems having aromatic and non-aromatic rings that have no ring heteroatoms, the term “Aryl” applies when the point of attachment is at an aromatic carbon atom (e.g., 5,6,7,8 tetrahydronaphthalene-2-yl is an aryl group as its point of attachment is at the 2-position of the aromatic phenyl ring).

“Cycloalkyl” refers to a saturated or partially saturated cyclic group of from 3 to 14 carbon atoms and no ring heteroatoms and having a single ring or multiple rings including fused, bridged, and spiro ring systems. For multiple ring systems having aromatic and non-aromatic rings that have no ring heteroatoms, the term “cycloalkyl” applies when the point of attachment is at a non-aromatic carbon atom (e.g., 5,6,7,8,-tetrahydronaphthalene-5-yl). The term “cycloalkyl” includes cycloalkenyl groups, such as adamantyl, cyclopropyl, cyclobutyl, cyclopentyl, cyclooctyl, and cyclohexenyl. The term “cycloalkenyl” is sometimes employed to refer to a partially saturated cycloalkyl ring having at least one site of >C═C<ring unsaturation.

“Halo” or “halogen” refers to fluoro, chloro, bromo, and iodo.

“Haloalkyl” refers to substitution of alkyl groups with 1 to 5 or in some embodiments 1 to 3 halo groups.

“Heteroaryl” refers to an aromatic group of from 1 to 14 carbon atoms and 1 to 6 heteroatoms selected from oxygen, nitrogen, and sulfur and includes single ring (e.g., imidazolyl) and multiple ring systems (e.g., benzimidazol-2-yl and benzimidazol-6-yl). For multiple ring systems, including fused, bridged, and spiro ring systems having aromatic and non-aromatic rings, the term “heteroaryl” applies if there is at least one ring heteroatom and the point of attachment is at an atom of an aromatic ring (e.g., 1,2,3,4-tetrahydroquinolin-6-yl and 5,6,7,8-tetrahydroquinolin-3-yl). In some embodiments, the nitrogen and/or the sulfur ring atom(s) of the heteroaryl group are optionally oxidized to provide for the N oxide (N→O), sulfinyl, or sulfonyl moieties. Examples of heteroaryl groups include, but are not limited to, pyridyl, furanyl, thienyl, thiazolyl, isothiazolyl, triazolyl, imidazolyl, imidazolinyl, isoxazolyl, pyrrolyl, pyrazolyl, pyridazinyl, pyrimidinyl, purinyl, phthalazyl, naphthylpryidyl, benzofuranyl, tetrahydrobenzofuranyl, isobenzofuranyl, benzothiazolyl, benzoisothiazolyl, benzotriazolyl, indolyl, isoindolyl, indolizinyl, dihydroindolyl, indazolyl, indolinyl, benzoxazolyl, quinolyl, isoquinolyl, quinolizyl, quianazolyl, quinoxalyl, tetrahydroquinolinyl, isoquinolyl, quinazolinonyl, benzimidazolyl, benzisoxazolyl, benzothienyl, benzopyridazinyl, pteridinyl, carbazolyl, carbolinyl, phenanthridinyl, acridinyl, phenanthrolinyl, phenazinyl, phenoxazinyl, phenothiazinyl, and phthalimidyl.

“Heterocyclic” or “heterocycle” or “heterocycloalkyl” or “heterocyclyl” refers to a saturated or partially saturated cyclic group having from 1 to 14 carbon atoms and from 1 to 6 heteroatoms selected from nitrogen, sulfur, or oxygen and includes single ring and multiple ring systems including fused, bridged, and spiro ring systems. For multiple ring systems having aromatic and/or non-aromatic rings, the terms “heterocyclic”, “heterocycle”, “heterocycloalkyl”, or “heterocyclyl” apply when there is at least one ring heteroatom and the point of attachment is at an atom of a non-aromatic ring (e.g., decahydroquinolin-6-yl). In some embodiments, the nitrogen and/or sulfur atom(s) of the heterocyclic group are optionally oxidized to provide for the N oxide, sulfinyl, sulfonyl moieties. Examples of heterocyclyl groups include, but are not limited to, azetidinyl, tetrahydropyranyl, piperidinyl, N-methylpiperidin-3-yl, piperazinyl, N-methylpyrrolidin-3-yl, 3-pyrrolidinyl, 2-pyrrolidon-1-yl, morpholinyl, thiomorpholinyl, imidazolidinyl, and pyrrolidinyl.

It should be understood that the aforementioned definitions encompass unsubstituted groups, as well as groups substituted with one or more other functional groups as is known in the art. For example, an alkyl, alkenyl, alkynyl, aryl, heteroaryl, cycloalkyl, or heterocyclyl group may be substituted with from 1 to 8, in some embodiments from 1 to 5, in some embodiments from 1 to 3, and in some embodiments, from 1 to 2 substituents selected from alkyl, alkenyl, alkynyl, alkoxy, acyl, acylamino, acyloxy, amino, quaternary amino, amide, imino, amidino, aminocarbonylamino, amidinocarbonylamino, aminothiocarbonyl, aminocarbonylamino, aminothiocarbonylamino, aminocarbonyloxy, aminosulfonyl, aminosulfonyloxy, aminosulfonylamino, aryl, aryloxy, arylthio, azido, carboxyl, carboxyl ester, (carboxyl ester)amino, (carboxyl ester)oxy, cyano, cycloalkyl, cycloalkyloxy, cycloalkylthio, guanidino, halo, haloalkyl, haloalkoxy, hydroxy, hydroxyamino, alkoxyamino, hydrazino, heteroaryl, heteroaryloxy, heteroarylthio, heterocyclyl, heterocyclyloxy, heterocyclylthio, nitro, oxo, oxy, thione, phosphate, phosphonate, phosphinate, phosphonamidate, phosphorodiamidate, phosphoramidate monoester, cyclic phosphoramidate, cyclic phosphorodiamidate, phosphoramidate diester, sulfate, sulfonate, sulfonyl, substituted sulfonyl, sulfonyloxy, thioacyl, thiocyanate, thiol, alkylthio, etc., as well as combinations of such substituents. When incorporated into the polymer of the present invention, such substitutions may be pendant or grafted groups, or may themselves form part of the polymer backbone.

It is to be understood by one of ordinary skill in the art that the present discussion is a description of exemplary embodiments only, and is not intended as limiting the broader aspects of the present invention.

Generally speaking, the present invention is directed to a liquid crystalline polymer that contains the following repeating units (1) to (5):

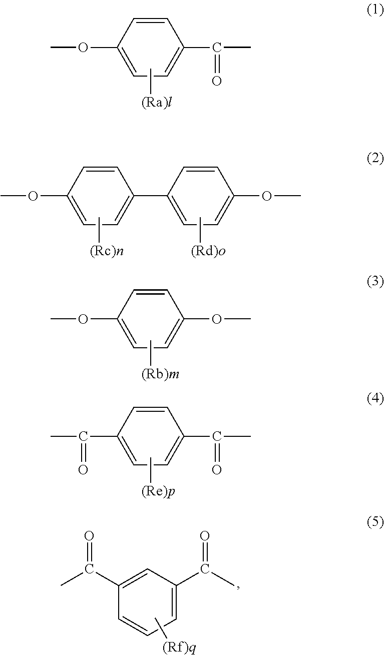

wherein,

Ra, Rb, Rc, Rd, Re and Rf are independently alkenyl, alkyl, alkynyl, aryl, heteroaryl, cycloalkyl, heterocyclyl, halo, or haloalkyl; and

l, m, n, o, p and q are independently an integer from 0 to 4, in some embodiments from 0 to 2, and in some embodiments, from 0 to 1.

By selectively controlling the nature and relative proportion of the repeating units (1)-(5), the present inventors have discovered the resulting polymer can have a relatively low melting temperature but still achieve a significant degree of chain entanglement such that the polymer exhibits good melt strength, which enables it to be readily employed in various melt-extruded articles. For example, the repeating units (1) may constitute from about 5 mole % to about 45 mole %, in some embodiments from about 15 mole % to about 42 mole %, and in some embodiments, from about 25 mole % to about 40 mole % of the polymer. Likewise, the repeating units (2), (3), (4), and (5) may each constitute from about 1 mole % to about 30 mole %, in some embodiments from about 5 mole % to about 25 mole %, and in some embodiments, from about 10 mole % to about 20 mole % of the polymer. Regardless of the exact molar amount employed, the molar ratio of repeating units (2) to the repeating units (3) is selectively controlled so that it is from about 0.6 to about 2.5, in some embodiments from about 0.7 to about 2.0, and in some embodiments, from about 0.8 to about 1.5. Furthermore, the molar ratio of repeating units (4) to the repeating units (5) is selectively controlled so that it is from about 0.6 to about 2.5, in some embodiments from about 0.7 to about 1.5, and in some embodiments, from about 0.8 to about 1.0. Typically, the repeating units (3) are used in a molar amount greater than the repeating units (2) such that the molar ratio is less than 1, and the repeating units (5) are used in a molar amount greater than the repeating units (4) such that the molar ratio is less than 1.

In certain embodiments, the repeating units (1) may be derived from 4-hydroxybenzoic acid (“HBA”) (l is 0), the repeating units (2) may be derived from 4,4′-biphenol (“BP”) (n and o are 0), the repeating units (3) may be derived from hydroquinone (“HQ”) (m is 0), the repeating units (4) may be derived from terephthalic acid (“TA”) (p is 0), and/or the repeating units (5) may be derived from isophthalic acid (“IA”) (q is 0).

Of course, it should be understood that other repeating units may also be employed in the polymer. For example, other aromatic hydroxycarboxylic repeating units may also be employed that are derived from aromatic hydroxycarboxylic acids other than HBA, such as, 4-hydroxy-4′-biphenylcarboxylic acid; 2-hydroxy-6-naphthoic acid (“HNA”); 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Likewise, other aromatic dicarboxylic repeating units may be employed that are derived from aromatic dicarboxylic acids other than TA and IA, such as 2,6-naphthalenedicarboxylic acid (“NDA”), diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Aromatic diol repeating units may also be employed that are derived from aromatic diols other than HQ and BP, such as resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids (e.g., cyclohexane dicarboxylic acid), diols, amides, amines, etc. Of course, in other embodiments, the polymer may be “wholly aromatic” in that it lacks repeating units derived from non-aromatic (e.g., aliphatic or cycloaliphatic) monomers.

Although not necessarily required, it may be desired that the liquid crystalline polymer contains a low content of repeating units derived from naphthenic hydroxycarboxylic acids and naphthenic dicarboxylic acids, such as NDA, HNA, or combinations thereof. That is, the total amount of repeating units derived from naphthenic hydroxycarboxylic and/or dicarboxylic acids (e.g., NDA, HNA, or a combination of HNA and NDA) is typically less than about 10 mol. %, in some embodiments less than about 5 mol. %, and in some embodiments, less than about 1 mol. % of the polymer. The liquid crystalline polymer may also contain a low content of repeating units derived from aromatic amides and aromatic amines, such as APAP, AP, or combinations thereof. That is, the total amount of repeating units derived from aromatic amides and/or amines (e.g., APAP, AP, or a combination of APAP and AP) is typically less than about 10 mol. %, in some embodiments less than about 5 mol. %, and in some embodiments, less than about 1 mol. % of the polymer. In particular embodiments, the polymer contains 0 mol. % of naphthenic hydroxycarboxylic acids (e.g., HNA), 0 mol. % of naphthenic dicarboxylic acids (e.g., NDA), 0 mol. % of aromatic amides (e.g., APAP), and/or 0 mol. % of aromatic amines (e.g., AP). In fact, the liquid crystalline polymer may be formed entirely from the repeating units (1)-(5) if so desired such that the total molar percentage of the repeating units (1)-(5) equals 100%.

The liquid crystalline polymer is synthesized in a melt polymerization process. The process may involve initially introducing the monomer(s) used to form the repeating units (1)-(5) (e.g., HBA, TA, IA, HQ, and BP) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, Ill, et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation.

In addition to the monomers and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 200° C. to about 400° C. For instance, one suitable technique for forming the polymer may include charging precursor monomers and acetic anhydride into the reactor, heating the mixture to a temperature of from about 90° C. to about 150° C. to acetylize the monomers (e.g., forming acetoxy), and then increasing the temperature to a temperature of from about 200° C. to about 400° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. The resin may also be in the form of a strand, granule, or powder.

Regardless of the particular method employed, the resulting polymer may have a relatively low melting temperature. For example, the melting temperature of the polymer may be from about 100° C. to about 280° C., in some embodiments from about 150° C. to about 280° C., in some embodiments from about 230° C. to about 275° C., and in some embodiments, from about 250° C. to about 270° C. The polymer may also have a low melt viscosity, such as from about 25 to about 150 Pa-s, in some embodiments from about 30 to about 125 Pa-s, and in some embodiments, from about 35 to about 100 Pa-s, determined at a shear rate of 1000 seconds⁻¹. Melt viscosity may be determined in accordance with ISO Test No. 11443:2005 at about 15° C. higher than the melting temperature of the polymer (e.g., at 280° C. for a polymer with a melting temperature of 264° C.).

Despite having a relatively low melting temperature and melt viscosity, the present inventors have discovered that the polymer can still exhibit good melt strength, which makes it particularly well suited for use in melt extrusion applications. The melt strength of the polymer can be characterized by the engineering stress and/or viscosity at a certain percent strain and at the melting temperature of the composition. As explained in more detail below, such testing may be performed in accordance with the ARES-EVF during which an extensional viscosity fixture (“EVF”) is used on a rotational rheometer to allow the measurement of the material stress versus percent strain. In this regard, the polymer can have a relatively high maximum engineering stress even at relatively high percent strains. For example, the polymer can exhibit its maximum engineering stress at a percent strain of from about 0.3% to about 1.5%, in some embodiments from about 0.4% to about 1.5%, and in some embodiments, from about 0.6% to about 1.2%. The maximum engineering stress may, for instance, range from about 340 kPa to about 600 kPa, in some embodiments from about 350 kPa to about 500 kPa, and in some embodiments, from about 370 kPa to about 420 kPa. Just as an example, at a percent strain of about 0.6%, the composition can exhibit a relatively high engineering stress of 340 kPa to about 600 kPa, in some embodiments from about 350 kPa to about 500 kPa, and in some embodiments, from about 360 kPa to about 400 kPa. The elongational viscosity may also range from about 350 kPa-s to about 1500 kPa-s, in some embodiments from about 500 kPa-s to about 1000 kPa-s, and in some embodiments, from about 600 kPa-s to about 900 kPa-s. Without intending to be limited by theory, the ability to achieve enhanced such an increased melt strength can allow a melt-extruded article (e.g., film, fiber, etc.) to better maintain its shape during melt extrusion without exhibiting a substantial amount of sag. The polymer can also have a relatively high storage modulus. The storage modulus of the polymer, for instance, may be from about 1 to about 250 Pa, in some embodiments from about 2 to about 200 Pa, and in some embodiments, from about 5 to about 100 Pa, as determined at the melting temperature of the polymer (e.g., about 260° C.) and at an angular frequency of 0.1 radians per second.

The liquid crystalline polymer can be employed in neat form within a polymer composition, or it can alternatively be blended with a wide variety of other components. In certain embodiments, for instance, an inorganic filler may be employed in a polymer composition in combination with the liquid crystalline polymer to improve the mechanical properties. The relative amount of the inorganic filler in the polymer composition may be selectively controlled to help achieve the desired properties. When employed, for example, fillers typically constitute from about 1 wt. % to about 40 wt. %, in some embodiments from about 2 wt. % to about 30 wt. %, and in some embodiments, from about 5 wt. % to about 20 wt. % of the polymer composition. Liquid crystalline polymers may likewise constitute from about 60 wt. % to about 99 wt. %, in some embodiments from about 70 wt. % to about 98 wt. %, and in some embodiments, from about 80 wt. % to about 95 wt. % of the polymer composition.

Any of a variety of inorganic fillers may generally be employed in the composition. In one embodiment, for example, inorganic fibers may be employed. Such fibers generally have a high degree of tensile strength relative to their mass. For example, the ultimate tensile strength of the fibers (determined in accordance with ASTM D2101) is typically from about 1,000 to about 15,000 Megapascals (“MPa”), in some embodiments from about 2,000 MPa to about 10,000 MPa, and in some embodiments, from about 3,000 MPa to about 6,000 MPa. To help maintain an insulative property, which is often desirable for use in certain applications, the high strength fibers may be formed from materials that are also generally insulative in nature, such as glass, ceramics (e.g., alumina or silica), etc., as well as mixtures thereof. Glass fibers are particularly suitable, such as E-glass, A-glass, C-glass, D-glass, AR-glass, R-glass, S1-glass, S2-glass, etc., and mixtures thereof.

Mineral fillers may also be employed, either alone or in combination with inorganic fibers. Clay minerals may be particularly suitable for use in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), illite ((K, H₃O)(Al,Mg,Fe)₂ (Si,Al)₄O₁₀[(OH)₂,(H₂O)]), montmorillonite (Na,Ca)_{0.33}(Al,Mg)₂Si₄O₁₀(OH)₂.nH₂O), vermiculite ((MgFe,Al)₃(Al,Si)₄O₁₀(OH)₂. 4H₂O), palygorskite ((Mg,Al)₂Si₄O₁₀(OH)-4(H₂O)), pyrophyllite (Al₂Si₄O₁₀(OH)₂), etc., as well as combinations thereof. In lieu of, or in addition to, clay minerals, still other mineral fillers may also be employed. For example, other suitable silicate fillers may also be employed, such as calcium silicate, aluminum silicate, mica, diatomaceous earth, wollastonite, and so forth. Mica, for instance, may be particularly suitable. There are several chemically distinct mica species with considerable variance in geologic occurrence, but all have essentially the same crystal structure. As used herein, the term “mica” is meant to generically include any of these species, such as muscovite (KAl₂(AlSi₃)O₁₀(OH)₂), biotite (K(Mg, Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K, Na)(Al,Mg,Fe)₂(Si,Al)₄O₁₀(OH)₂), etc., as well as combinations thereof.

Still other additives that can be included in the composition may include, for instance, antimicrobials, lubricants, pigments (e.g., carbon black), antioxidants, stabilizers, surfactants, waxes, solid solvents, flow aids, and other materials added to enhance properties and processability.

As noted above, the liquid crystalline polymer of the present invention is particularly well suited for use in melt-extruded articles, such as films and fibers. Any of variety of different techniques may generally be used to form the polymer composition into a melt-extruded article. Suitable film-forming techniques may include, for instance, flat sheet die extrusion, blown film extrusion, tubular trapped bubble film processes, etc. In one particular embodiment, a flat sheet die extrusion process is employed that utilizes a T-shaped die. The die typically contains arms that extend at right angles from an initial extrusion channel. The arms may have a slit along their length to allow the polymer melt to flow therethrough. Examples of such film extrusion processes are described, for instance, in U.S. Pat. No. 4,708,629 to Kasamatsu. Fibers may likewise be melt-extruded using a wide variety of known processes. Typically, such fibers are formed by extruding the composition through a spinneret, quenching the resulting fibers, and then attenuating the quenched fibers in a fiber draw unit.

In one particular embodiment, a film may be formed from the polymer composition that has a thickness of from about 0.1 micrometers to about 25 millimeters. Thin films may, for instance, have a thickness of from about 0.1 micrometers to about 0.5 millimeters, in some embodiments from about 0.5 to about 500 micrometers, and in some embodiments, from about 1 to about 200 micrometers. Likewise, thick films (or sheets) may have a thickness of from about 0.5 millimeters to about 25 millimeters, in some embodiments from about 0.6 to about 20 millimeters, and in some embodiments, from about 1 to about 10 millimeters.

Due to the unique properties of the liquid crystalline polymer, the present inventors have discovered that a film formed therefrom can exhibit good mechanical properties. One parameter that is indicative of the relative strength of the film is the tensile strength, which is equal to the peak stress obtained in a stress-strain curve. Desirably, the film exhibits a tensile strength in the machine direction (“MD”) of from about 100 to about 800 Megapascals (MPa), in some embodiments from about 150 to about 600 MPa, and in some embodiments, from about 200 to about 400 MPa, and a tensile strength in the transverse direction (“TD”) of from about 1 to about 50 Megapascals (MPa), in some embodiments from about 5 to about 40 MPa, and in some embodiments, from about 10 to about 30 MPa. The film may also exhibit an elongation at break in the MD and/or TD of from about 0.5% to about 10%, in some embodiments from about 0.8% to about 6%, and in some embodiments, from about 1% to about 5%. Although possessing good strength, the film is not too stiff. One parameter that is indicative of the relative stiffness of the film is Young's modulus. For example, the film typically exhibits a Young's modulus in the MD of from about 10,000 to about 80,000 MPa, in some embodiments from about 12,000 to about 50,000 MPa, and in some embodiments, from about 15,000 to about 30,000 MPa, and a Young's modulus in the TD of from about 300 to about 10,000 MPa, in some embodiments from about 500 to about 5,000 MPa, and in some embodiments, from about 800 to about 3,000 MPa. The tensile properties described above may be determined in accordance with ASTM D882-12. The film may likewise exhibit excellent tear strength as determined in accordance with ASTM D1922-09. For example, the film may exhibit a tear strength in the MD and/or CD of from about 1 to about 100 grams-force, in some embodiments from about 5 to about 50 grams-force, and in some embodiments, from about 15 to about 35 grams-force.

The resulting film may be used as a stand-alone product or incorporated into other types of products. For example, the film can be used in a stand-alone form as a shrink film, cling film, stretch film, sealing film, etc., or to form a package for food products (e.g., snack packaging, heavy duty bags, grocery sacks, baked and frozen food packaging, etc.), packaging for medical products, packaging for biological materials, packaging for electronic devices, thermoformed articles, etc. The film can also be formed into a laminate material having a variety of different uses, such as in claddings, multi-layer print wiring boards for semiconductor package and mother boards, flexible printed circuit board, tape automated bonding, tag tape, for electromagnetic waves, probe cables, communication equipment circuits, etc. In one particular embodiment, a laminate is employed in a flexible printed circuit board that contains a conductive layer and a film formed as described herein. The conductive layer may be in the form of a metal plate or foil, such as those containing gold, silver, copper, nickel, aluminum, etc. (e.g., copper foil). The film may be applied to the conductive layer using known techniques, or the conductive layer may alternatively be applied to the film using techniques such as ion beam sputtering, high frequency sputtering, direct current magnetron sputtering, glow discharge, etc. If desired, the film may be subjected to a surface treatment on a side facing the conductive layer so that the adhesiveness between the film and conductive layer is improved. Examples of such surface treatments include, for instance, corona discharge treatment, UV irradiation treatment, plasma treatment, etc. Adhesives may also be employed between the film and the conductive layer as is known in the art. Suitable adhesives may include epoxy, phenol, polyester, nitrile, acryl, polyimide, polyurethane resins, etc. The resulting laminate may have a two-layer structure containing only the film and conductive layer. Alternatively, a multi-layered laminate may be formed, such as a three-layer structure in which conductive layers are placed on both sides of a film, a five-layer structure in which films and conductive layers are alternately stacked, and so forth. Regardless of the number of layers, various conventional processing steps may be employed to provide the laminate with sufficient strength. For example, the laminate may be pressed and/or subjected to heat treatment as is known in the art.

A variety of different techniques may be employed to form a printed circuit board from such a laminate structure. In one embodiment, for example, a photo-sensitive resist is initially disposed on the conductive layer and an etching step is thereafter performed to remove a portion of the conductive layer. The resist can then be removed to leave a plurality of conductive pathways that form a circuit. If desired, a cover film may be positioned over the circuit, which may also be formed in accordance with the present invention. Regardless of how it is formed, the resulting printed circuit board can be employed in a variety of different electronic components. As an example, flexible printed circuit boards may be employed in desktop computers, cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, etc. Of course, the polymer composition may also be employed in electronic components, such as described above, in devices other than printed circuit boards. For example, the polymer composition may be used to form high density magnetic tapes, wire covering materials, etc.

The present invention may be better understood with reference to the following example.

### Test Methods

Melting Temperature:

The melting temperature (“Tm”) may be determined by differential scanning calorimetry (“DSC”) as is known in the art. The melting temperature is the differential scanning calorimetry (DSC) peak melt temperature as determined by ISO Test No. 11357-3:2011. Under the DSC procedure, samples may be heated and cooled at 20° C. per minute as stated in ISO Standard 10350-1:2007 using DSC measurements conducted on a TA Q2000 Instrument.

Melt Viscosity:

The melt viscosity (Pa-s) may be determined in accordance with ISO Test No. 11443:2005 at a shear rate of 1000 s⁻¹ and temperature of about 15° C. above the melting temperature (e.g., at 280° C. for a melting temperature of 264° C.) using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod may be 233.4 mm.

Melt Elongation:

Melt elongation properties (i.e., stress, strain, and elongational viscosity) may be determined in accordance with the ARES-EVF: Option for Measuring Extensional Velocity of Polymer Melts, A. Franck, which is incorporated herein by reference. In this test, an extensional viscosity fixture (“EVF”) is used on a rotational rheometer to allow the measurement of the engineering stress at a certain percent strain. More particularly, a thin rectangular polymer melt sample is adhered to two parallel cylinders: one cylinder rotates to wind up the polymer melt and lead to continuous uniaxial deformation in the sample, and the other cylinder measures the stress from the sample. An exponential increase in the sample length occurs with a rotating cylinder. Therefore, the Hencky strain (ε_{H}) is determined as function of time by the following equation: ε_{H}(t)=In(L(t)/Lₒ), where Lₒ is the initial gauge length of and L(t) is the gauge length as a function of time. The Hencky strain is also referred to as percent strain. Likewise, the elongational viscosity is determined by dividing the normal stress (kPa) by the elongation rate (s⁻¹). Specimens tested according to this procedure have a width of 1.27 mm, length of 30 mm, and thickness of 0.8 mm. The test may be conducted at the melting temperature (e.g., about 360° C.) and elongation rate of 2 s⁻¹.

Tensile Properties:

The tensile properties (e.g., tensile strength, Young's modulus, and elongation at break) of a melt-extruded film sample may be determined in accordance with ASTM D882-12. The film thickness may be approximately 101.6 micrometers. Two sets of film specimens may be prepared for testing in the machine direction and transverse direction. The testing temperature, gage length, and speed may be 23° C., 5 inches, and 0.5 inch/min, respectively.

Tear Strength:

The tear strength of a film sample may be determined in accordance with ASTM D1922-09. Ten (10) samples may be cut in the machine direction and in the transverse direction. A sample is positioned in the tester and clamped in place. A cutting knife in the tester is used to create a slit in the sample, which ends 43 millimeters from the far edge of the sample. The pendulum is released to propagate the slit through the remaining 43 millimeters. The energy loss by the pendulum is used to calculate an average tearing force. The testing temperature may be 23° C.

### Example

A 2-L flask is charged with HBA (290.1 grams, 2.10 moles), IA (164.5 grams, 0.99 moles), TA (159.5 grams, 0.96 moles), HQ (109.0 grams, 0.99 moles), BP (178.8 grams, 0.96 moles), and 60 mg of potassium acetate. The flask next is equipped with C-shaped stirrer, a thermal couple, a gas inlet, and distillation head. The flask is placed under a low nitrogen purge and acetic anhydride (99.7% assay, 630 g) was added. The milky-white slurry is agitated at 75 rpm and heated to 140° C. over the course of 95 minutes using a fluidized sand bath. After this time, the mixture was then gradually heated to 320° C. steadily over 280 minutes. Reflux is seen once the reaction exceeds 140° C. and the overhead temperature increases to approximately 115° C. as acetic acid byproduct is removed from the system. During the heating, the mixture grows yellow and slightly more viscous and the vapor temperature gradually drops to 90° C. Once the mixture has reached 370° C., the nitrogen flow is stopped. The flask is evacuated below 20 psi and the agitation is slowed to 30 rpm over the course of 45 minutes. As the time under vacuum progressed, the mixture grows viscous. After 36 minutes, in the final vacuum step, 1-3 torque is recorded as seen by the strain on the agitator motor. The reaction is then stopped by releasing the vacuum and stopping the heat flow to the reactor. The flask is cooled and then polymer is recovered as a solid, dense yellow-brown plug. Sample for analytical testing is obtained by mechanical size reduction.

The melting temperature and crystallization temperatures are determined by DSC analysis (2^{nd} cycle) and are 255-264° C. and 220° C., respectively. The melt viscosity is about 67 Pa-s (determined at 1000 s⁻¹ and temperature of 280° C.).

To form the film samples, pellets of the liquid crystalline polymers are dried at 150° C. overnight. Thereafter, the polymers are supplied to the feed throat of a ZSK-25 WLE co-rotating, fully intermeshing twin screw extruder in which the length of the screw is 750 millimeters, the diameter of the screw is 25 millimeters, and the L/D ratio is 30. The extruder has temperature zones 1-9, which may be set to the following temperatures: 330° C., 330° C., 310° C., 310° C., 310° C., 310° C., 320° C., 320° C., and 320° C., respectively. Once melt blended, the samples are extruded through T-die plate to make a film form. The film is stretched and collected via rollers. Once formed, the film sample is tested for its tensile properties. The results are set forth in the table below.

| Property | MD | TD |
|---|---|---|
| Tensile Strength (MPa) | 286 | 25 |
| Elongation (%) | 1.9 | 4.5 |
| Young's Modulus (MPa) | 17,673 | 1,534 |
| Tear Strength (grams-force) | 18.8 | 26.9 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A melt-polymerized liquid crystalline polymer comprising repeating units (1) to (5): 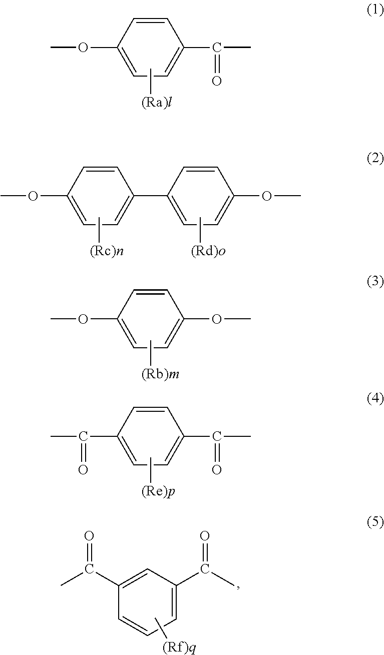
wherein,
Ra, Rb, Rc, Rd, Re and Rf are independently alkenyl, alkyl, alkynyl, aryl, heteroaryl, cycloalkyl, heterocyclyl, halo, or haloalkyl;
l, m, n, o, p and q are independently an integer from 0 to 4;
the repeating units (1) constitute from about 5 mole % to about 45 mole % of the polymer;
the molar ratio of repeating units (2) to the repeating units (3) is from about 0.6 to about 2.5; and
the molar ratio of repeating units (4) to the repeating units (5) is from about 0.6 to about 2.5.

2. The liquid crystalline polymer of claim 1, wherein the repeating units (2), (3), (4), and (5) each constitutes from about 1 mole % to about 30 mole % of the polymer.

3. The liquid crystalline polymer of claim 1, wherein the repeating units (3) are used in a molar amount greater than the repeating units (2).

4. The liquid crystalline polymer of claim 1, wherein the repeating units (5) are used in a molar amount greater than the repeating units (4).

5. The liquid crystalline polymer of claim 1, wherein l, m, n, o, p, and/or q are 0.

6. The liquid crystalline polymer of claim 1 wherein the repeating units (1) are derived from HBA, the repeating units (2) are derived from BP, the repeating units (3) are derived from HQ, the repeating units (4) are derived from TA, and the repeating units (5) are derived from IA.

7. The liquid crystalline polymer of claim 1, wherein the polymer is wholly aromatic.

8. The liquid crystalline polymer of claim 1, wherein the polymer contains less than about 5 mol. % of repeating units derived from NDA, HNA, or a combination thereof.

9. The liquid crystalline polymer of claim 1, wherein the polymer contains less than about 5 mol. % of repeating units derived from NDA, HNA, or a combination thereof.

10. The liquid crystalline polymer of claim 1, wherein the total molar percentage of the repeating units (1)-(5) equals 100%.

11. The liquid crystalline polymer of claim 1, wherein the polymer has a melting temperature of from about 100° C. to about 280° C.

12. The liquid crystalline polymer of claim 1, wherein the polymer has a melt viscosity of from about 25 to about 150 Pa-s, as determined in accordance with ISO Test No. 11443:2005 at a shear rate of 1000 seconds⁻¹ and temperature of about 15° C. higher than the melting temperature of the polymer.

13. A polymer composition comprising the liquid crystalline polymer of claim 1.

14. The polymer composition of claim 13, wherein the polymer composition comprises a filler.

15. A melt-extruded article comprising the polymer composition of claim 13.

16. The melt-extruded article of claim 15, wherein the article is a fiber.

17. The melt-extruded article of claim 15, wherein the article is a film.

18. The melt-extruded article of claim 17, wherein the film has a thickness of from about 0.1 micrometers to about 0.5 millimeters.

19. The melt-extruded article of claim 17, wherein the film has a thickness of from about 0.5 millimeters to about 25 millimeters.

20. A method for forming the liquid crystalline polymer of claim 1, the method comprising supplying monomers for the repeating units (1)-(5) to a reactor vessel to form a reaction mixture, and heating the reaction mixture to initiate a melt polycondensation reaction that forms the polymer.

21. The method of claim 20, wherein at least one of the monomers is acetylated before being supplied to the reactor vessel.

22. The method of claim 21, further comprising supplying an acetylating agent to the reactor vessel so that the reaction mixture comprises the acetylating agent and the monomers.

23. The method of claim 20, wherein the monomers include HBA, BP, HQ, TA, and IA.
